(19) United States
(12) Patent Application Publication
(10) Pub. No.: US 2011/0184672 A1
(43) Pub. Date: Jul. 28, 2011

(54) INSULATION DIAGNOSTIC UNIT AND ALGORITHM FOR ELECTRIC MACHINE, AND EQUIPMENT INCLUDING THE DIAGNOSTIC UNIT

(75) Inventors: Shuya Hagiwara, Mito (JP); Koji Obata, Hitachi (JP); Yoshimi Kurahara, Hitachi (JP); Chie Omatsu, Hitachi (JP)

(73) Assignee: Hitachi, Ltd.

(21) Appl. No.: 13/012,119

(22) Filed: Jan. 24, 2011

(30) Foreign Application Priority Data
Jan. 26, 2010 (JP) 2010-013992

(51) Int. Cl. G06F 19/00

(52) U.S. Cl. 702/58

(57) ABSTRACT

Partial discharge occurring in a continuously operated electric machine is monitored all the time. Even when the electric machine is mounted in mobility equipment, the partial discharge is monitored all the time. An insulation diagnostic unit includes: an instrument that performs spectrum analysis on an output of a sensor disposed near the electric machine; a data table in which an output of a load detection method for the electric machine and an output of the spectrum analysis instrument are recorded; a first routine that obtains a correlation coefficient on the basis of plural data items concerning the magnitudes of a spectrum relevant to a specific frequency, which is obtained by the spectrum analysis instrument, out of data items recorded in the data table, and plural data items of a load obtained at the times of measurement of the plural data items; and a second routine that classifies the noted spectrum relevant to the specific frequency into a spectrum of an environmental electromagnetic wave or a spectrum of an electromagnetic wave due to partial discharge from the electric machine on the basis of the value of the correlation coefficient obtained by the first routine.

### CLAIM OF PRIORITY

The present application claims priority from Japanese Patent application serial no. 2010-013992, filed on Jan. 26, 2010, the content of which is hereby incorporated by reference into this application.

### FIELD OF THE INVENTION

The present invention relates to an insulation diagnostic unit and algorithm for an electric machine that measure an electromagnetic wave deriving from partial discharge which occurs in an insulator of an electric machine, and that detect a premonitory phenomenon prior to occurrence of, especially, a breakdown, and to equipment including the diagnostic unit.

### BACKGROUND OF THE INVENTION

Electric machines including a motor and being closely involved in industries and daily life, and facilities for power generation, power transmission, and power transformation serving as power sources for the electric machines are pieces of infrastructural equipment that support modern society. If the electric machines fail, social activities are seriously affected. The electric machines are therefore requested to be highly reliable.

However, as long as the electric machines are industrially manufactured, deterioration in performance due to a defect occurring at a factory or due to long-term use is unavoidable. If part of the electric machine relevant to insulation is damaged, it would be a fatal damage. Therefore, a defect in the part should be discovered and coped with as early as possible.

As an effective approach to detection of an insulation defect in an electric machine, partial discharge is detected as a premonitory phenomenon of a breakdown. Further, as one of approaches to detection of the partial discharge, there is a method of measuring an electromagnetic wave generated during discharge. The method has the merit that since a signal is measured in a non-contact manner using an external antenna or sensor without the necessity of manipulating an electric machine that is an object, while the electric machine is in operation, the measurement can be readily achieved.

By the way, the antenna or sensor catches an environmental electromagnetic wave such as a communication wave or a broadcast wave. Therefore, a technology for separating and extracting an electromagnetic wave, which derives from partial discharge, from the environmental electromagnetic wave is requested. Proposals have been made in literatures concerning related arts in efforts to overcome the drawback.

In relation to a related art described in patent document 1 (JP-A-6-201754), a proposal has been made of a method of removing a frequency spectrum of an environmental electromagnetic wave that is granted permission to use in an area where an electric machine is disposed, and recognizing the remaining spectrum as an electromagnetic wave generated from the machine.

In patent document 2 (JP-A-2003-43094), a description is made of a method of measuring an electromagnetic wave received when partial discharge does not occur in an electric machine that is an object, storing a frequency spectrum of the electromagnetic wave as a spectrum of an environmental electromagnetic wave, comparing a frequency spectrum, which is observed when the electric machine is in operation, with the stored spectrum of the environmental electromagnetic wave, and thus sensing partial discharge.

In patent document 3 (JP-A-10-210647), a description is made of a method of detecting a frequency spectrum of an environmental electromagnetic wave, selecting a frequency band in which the frequency spectrum is seldom observed, and thus observing a spectrum due to partial discharge. In patent document 4 (JP-A-2006-329636), a description is made of a method of selecting a frequency band, in which a few environmental electromagnetic waves fall, using a sensor sensitive to a narrow frequency band, and thus observing the frequency band.

As mentioned above, many technologies have been proposed in relation to the fact that when partial discharge is detected as a premonitory phenomenon of a breakdown by measuring an electromagnetic wave, the electromagnetic wave should be separated or extracted from an environmental electromagnetic wave. The technologies have drawbacks.

For example, the method described in the patent document 1 does not take account of an environmental frequency that changes from one to another with a change of areas where the electric machine exists in a case where an electric machine is an onboard machine of mobility equipment that moves between the areas between which the environmental frequency that is granted permission to use differs from one to another.

In the method described in the patent document 2, a spectrum of an environmental electromagnetic wave has to be measured with the operation of an electric machine ceased. It is hard to adopt the method for the electric machine that has to be continuously operated. In particular, when the electric machine is an onboard machine of mobility equipment, the mobility equipment has to be moved to a place of initial measurement for the purpose of measurement. In addition, the mobility equipment cannot be used during the measurement. Besides, the insulation performance of the electric machine cannot be measured until the next measurement timing.

According to the methods described in the patent documents 3 and 4, measurement has to be performed when partial discharge from an electric machine does not occur or occurs to an unserious extent, and a spectrum of an environmental electromagnetic wave has to be then discriminated. It is hard to adopt the methods for the electric machine that has to be continuously operated.

Further, the foregoing technologies cannot separate or discriminate a transient electromagnetic wave such as an illegal electromagnetic wave.

Accordingly, an object of the present invention is to provide an insulation diagnostic unit and algorithm for an electric machine capable of monitoring all the time a state of partial discharge which occurs in an electric machine to be continuously operated, or especially, in an electric machine that is an onboard machine of mobility equipment, and equipment including the diagnostic unit.

### SUMMARY OF THE INVENTION

An insulation diagnostic unit for an electric machine in accordance with the present invention includes: a sensor disposed near an electric machine; an instrument that performs spectrum analysis on an output of the sensor; a load detection method for the electric machine; a data table in which an output of the load detection method and an output of the spectrum analysis instrument are recorded; a first routine that notes a spectrum relevant to a specific frequency, which is obtained by the spectrum analysis instrument, from among data items recorded in the data table, and obtains a correlation coefficient on the basis of plural data items concerning the magnitudes of the noted spectrum and plural data items of a load detected at the times of measurement of the plural data items; and a second routine that classifies the noted spectrum relevant to the specific frequency into a spectrum of an environmental electromagnetic wave or a spectrum of an electromagnetic wave due to partial discharge from the electric machine on the basis of the value of the correlation coefficient obtained by the first routine.

Preferably, a third routine that sequentially changes the spectrum relevant to the specific frequency, which is noted from among the data items recorded in the data table, and repeatedly executes the first routine and second routine is included in order to obtain frequency components of an electromagnetic wave due to partial discharge from the electric machine.

Preferably, the electric machine and the insulation diagnostic unit for the electric machine are mounted in mobility equipment.

Preferably, the electric machine and the insulation diagnostic unit for the electric machine are mounted in rotative equipment.

Preferably, when the value of the correlation coefficient obtained by the first routine is close to 1, the spectrum concerned is recognized as a spectrum of an electromagnetic wave due to partial discharge. When the value is close to 0, the spectrum concerned is recognized as a spectrum of an environmental electromagnetic wave.

Preferably, a detector that detects a position of mobility equipment and a memory in which electromagnetic-wave frequencies that are granted permission to use are stored in association with areas in which the position of the mobility equipment exists are further included. Based on an output of the detector that detects the position of the mobility equipment, the electromagnetic-wave frequency stored in the memory in association with the area where the position exists is excluded from an output of the spectrum analysis instrument, and the resultant data is recorded in the data table.

According to an insulation diagnostic algorithm for an electric machine in accordance with the present invention, data obtained by performing spectrum analysis on an electromagnetic wave measured around an electric machine, and a load on the electric machine are fetched. Plural data items of a specific spectrum out of data items resulting from the spectrum analysis are collated with the load on the electric machine. The specific spectrum whose magnitude varies along with a change in the load on the electric machine is recognized as frequency components of an electromagnetic wave due to partial discharge from the electric machine, and a spectrum whose magnitude is independent of the change in the load is recognized as frequency components of an environmental electromagnetic wave.

Preferably, pieces of information on electromagnetic-wave frequencies that are granted permission to use are preserved in association with areas. When the electric machine exists in any of the areas, the electromagnetic-wave frequency that is granted permission to use in the area is excluded from the data resulting from the spectrum analysis. The plural data items of the specific spectrum are then collated with the load on the electric machine.

Equipment including an insulation diagnostic unit for an electric machine in accordance with the present invention includes an electric machine, and an insulation diagnostic unit for an electric machine including: a sensor disposed near the electric machine; an instrument that performs spectrum analysis on an output of the sensor; a load detection method for the electric machine; a data table in which an output of the load detection method and an output of the spectrum analysis instrument are recorded; a first routine that notes a spectrum relevant to a specific frequency, which is obtained by the spectrum analysis instrument, from among data items recorded in the data table, and obtains a correlation coefficient on the basis of plural data items concerning the magnitudes of the spectrum, and plural data items of a load; and a second routine that classifies the noted spectrum relevant to the specific frequency into a spectrum of an environmental electromagnetic wave or a spectrum of an electromagnetic wave due to partial discharge from the electric machine according to the value of the correlation coefficient obtained by the first routine.

Preferably, the equipment is mobility equipment.

Preferably, the equipment is rotative equipment.

Preferably, a detector that detects a position of mobility equipment, and a memory in which electromagnetic-wave frequencies that are granted permission to use are stored in association with areas in which the position of the mobility equipment exists are further included. Based on an output of the detector that detects the position of the mobility equipment, the electromagnetic-wave frequency stored in the memory in association with the area in which the position exists is excluded from the output of the spectrum analysis instrument, and the resultant data is recorded in the data table.

According to the present invention, an electromagnetic wave deriving from partial discharge from an electric machine can be separated or discriminated from an environmental electromagnetic wave without the necessity of ceasing operation of the electric machine. As a result, since information on the partial discharge occurring in the electric machine can always be grasped, a change in insulation performance of the electric machine can be recognized without a delay.

### BRIEF DESCRIPTION OF THE INVENTION

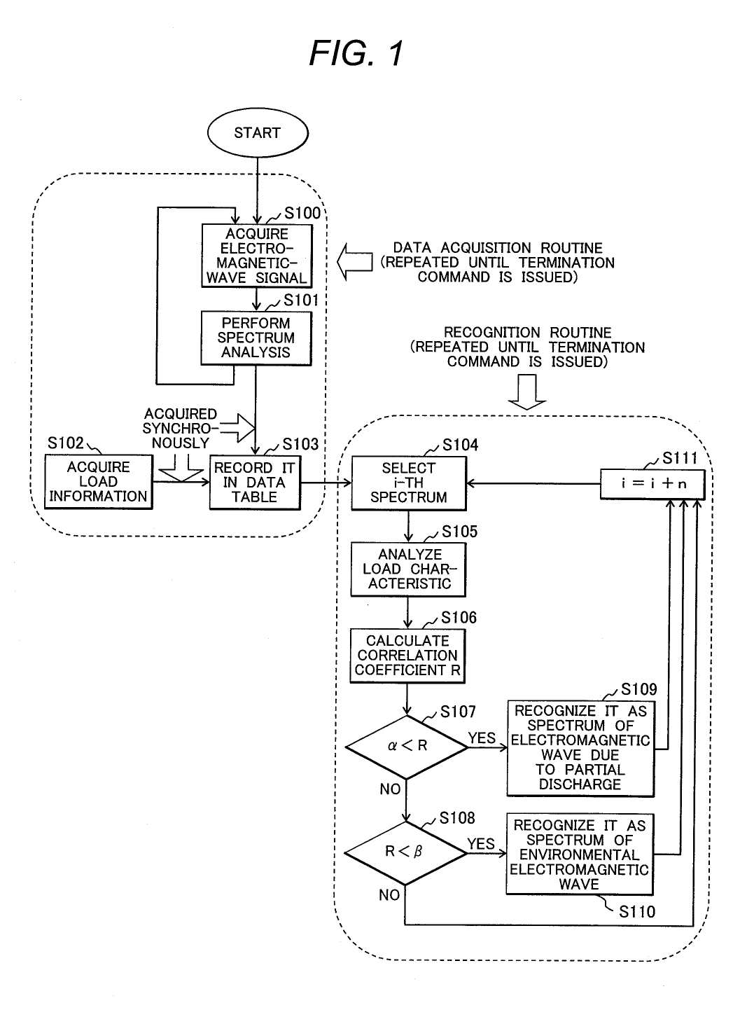

FIG. 1 is a flowchart showing a method of discriminating an electromagnetic-wave spectrum in accordance with the present invention;

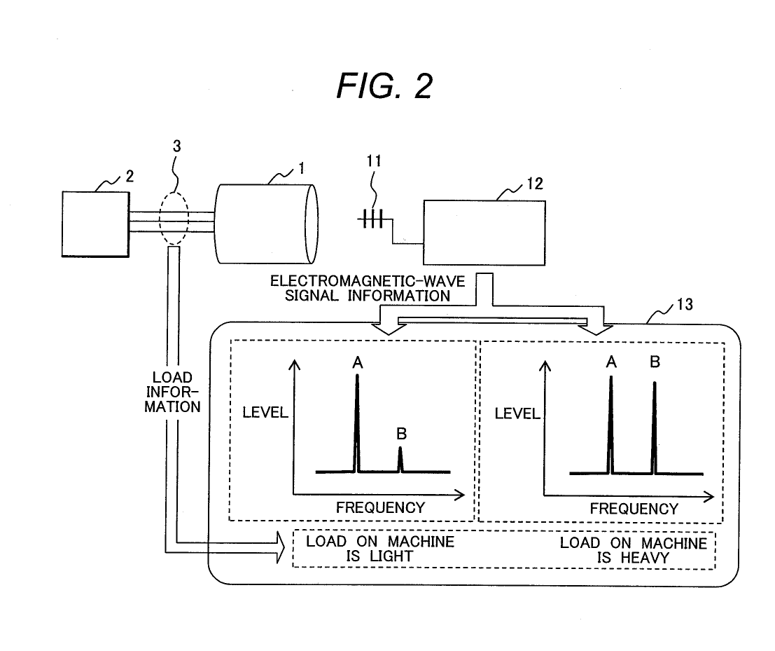

FIG. 2 is a diagram showing an overall constitution of a unit employed according to a partial discharge detection method for an electric machine in accordance with the present invention;

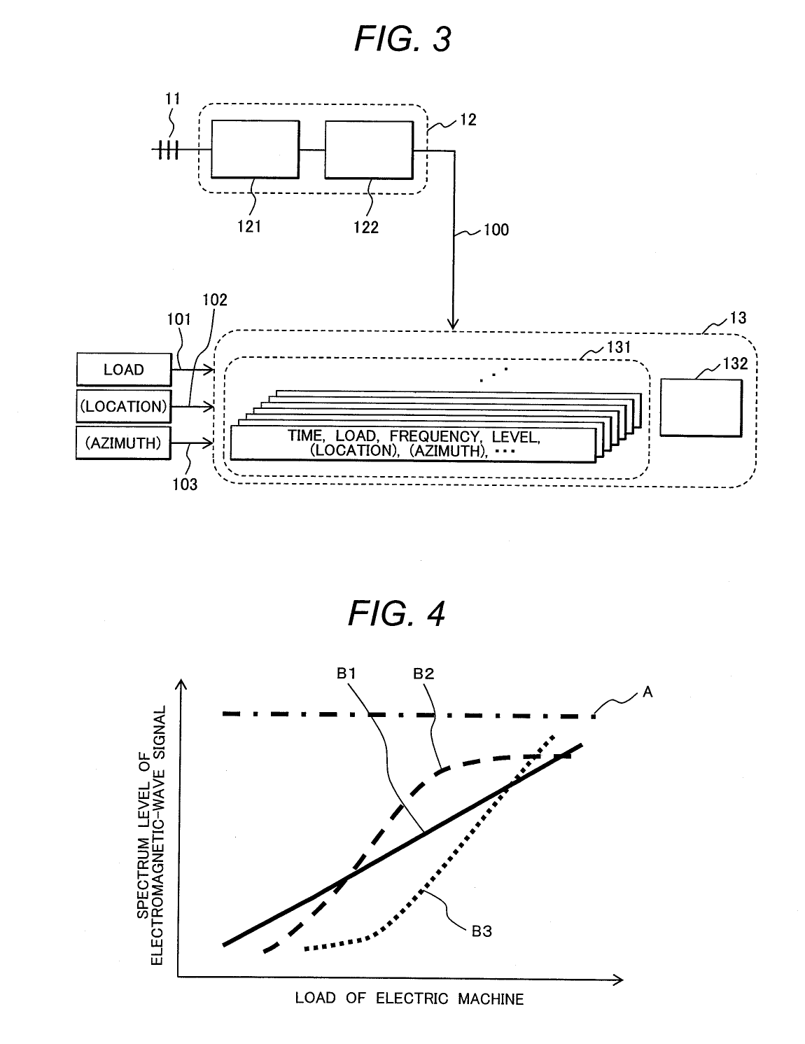

FIG. 3 is a functional block diagram showing a process of data processing in accordance with an embodiment of the present invention;

FIG. 4 is a characteristic diagram showing an example of a characteristic of an electromagnetic-wave spectrum with respect to a load on the electric machine;

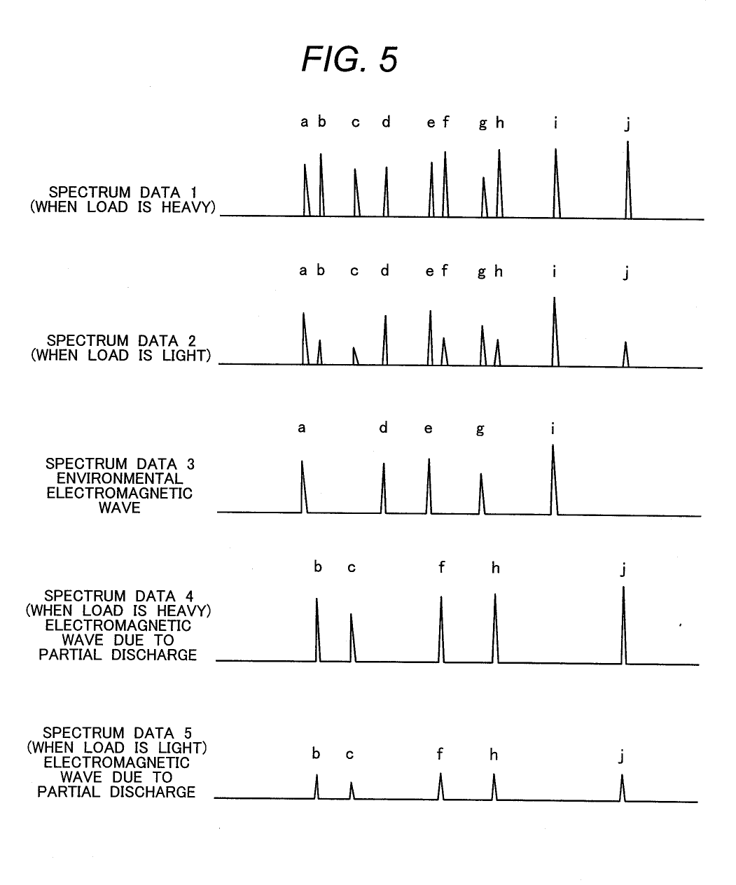

FIG. 5 is a diagram showing the relationship among data of a spectrum of a measured electromagnetic wave, data of a spectrum of an environmental electromagnetic wave, and data of a spectrum due to partial discharge;

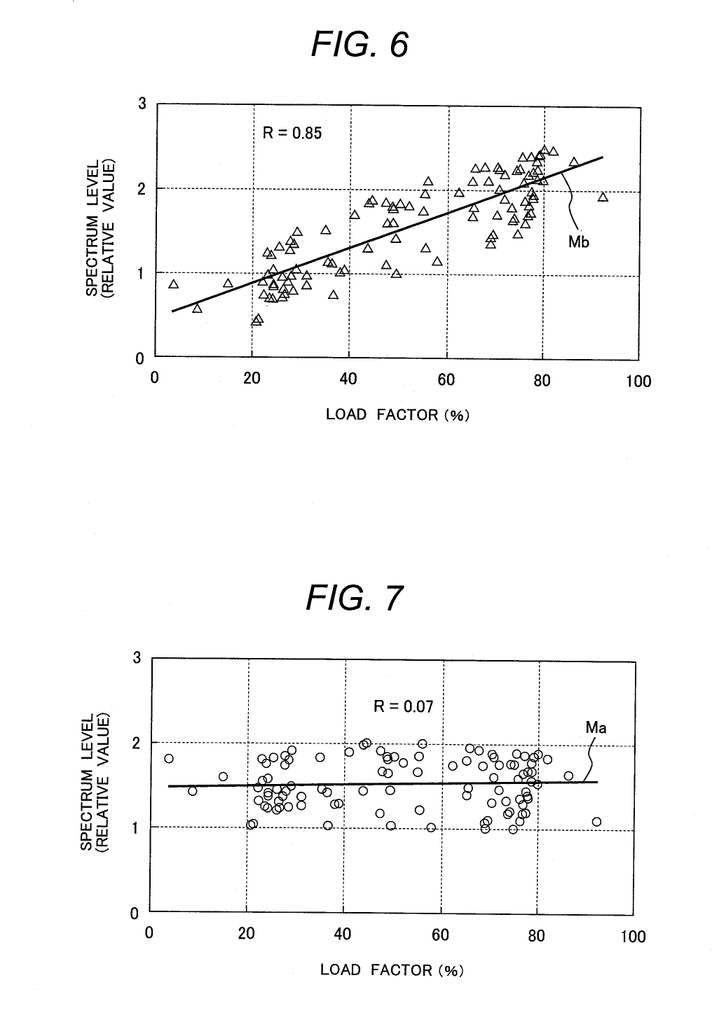

FIG. 6 is a diagram showing an example of a characteristic of a spectrum level of an electromagnetic wave, which is an electromagnetic wave due to partial discharge, with respect to a load;

FIG. 7 is a diagram showing an example of a characteristic of a spectrum level of an electromagnetic wave, which is an environmental electromagnetic wave, with respect to a load;

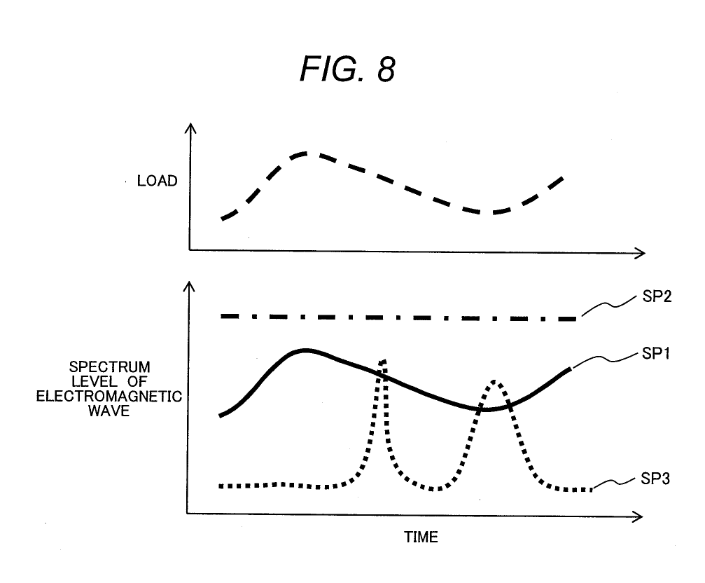

FIG. 8 is an explanatory diagram signifying that electromagnetic waves are discriminated from one another according to time-passing changes in frequency spectrum levels of the electromagnetic waves occurring when a load changes along with the passage of time;

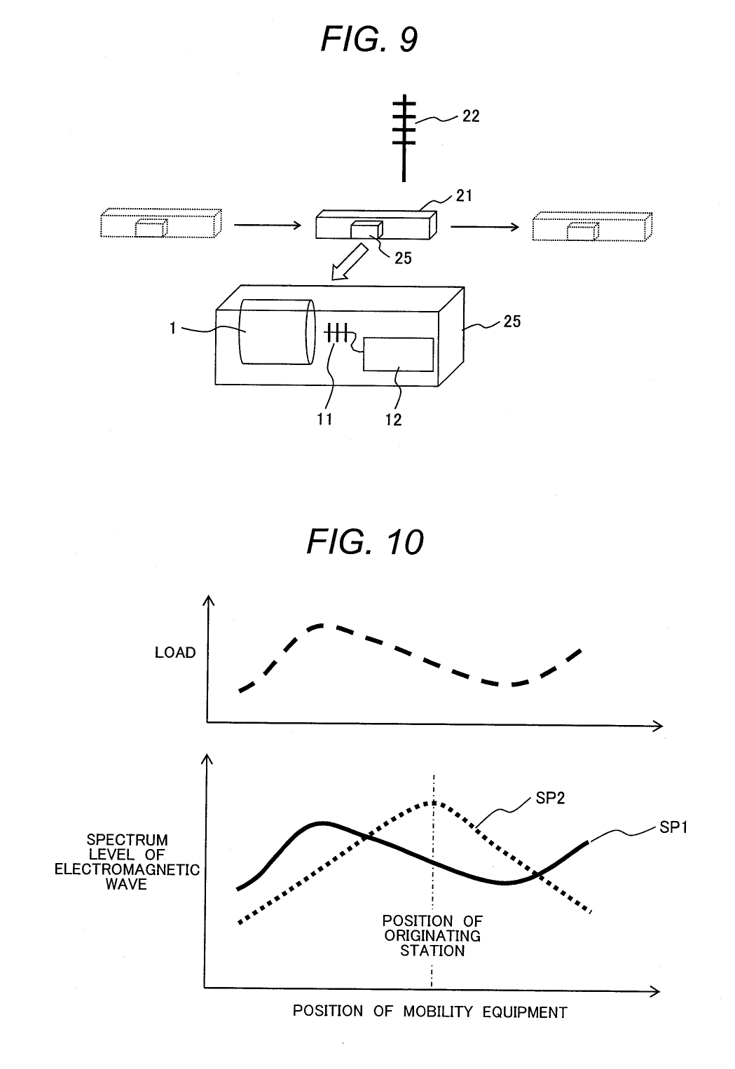

FIG. 9 is a conceptual diagram showing the relationship between mobility equipment and an environmental-electromagnetic wave originating station;

FIG. 10 is a characteristic diagram showing a frequency spectrum level of an electromagnetic wave with respect to a position of mobility equipment;

FIG. 11 is a conceptual diagram showing the relationship between azimuth movable equipment and the environmental-electromagnetic wave originating station;

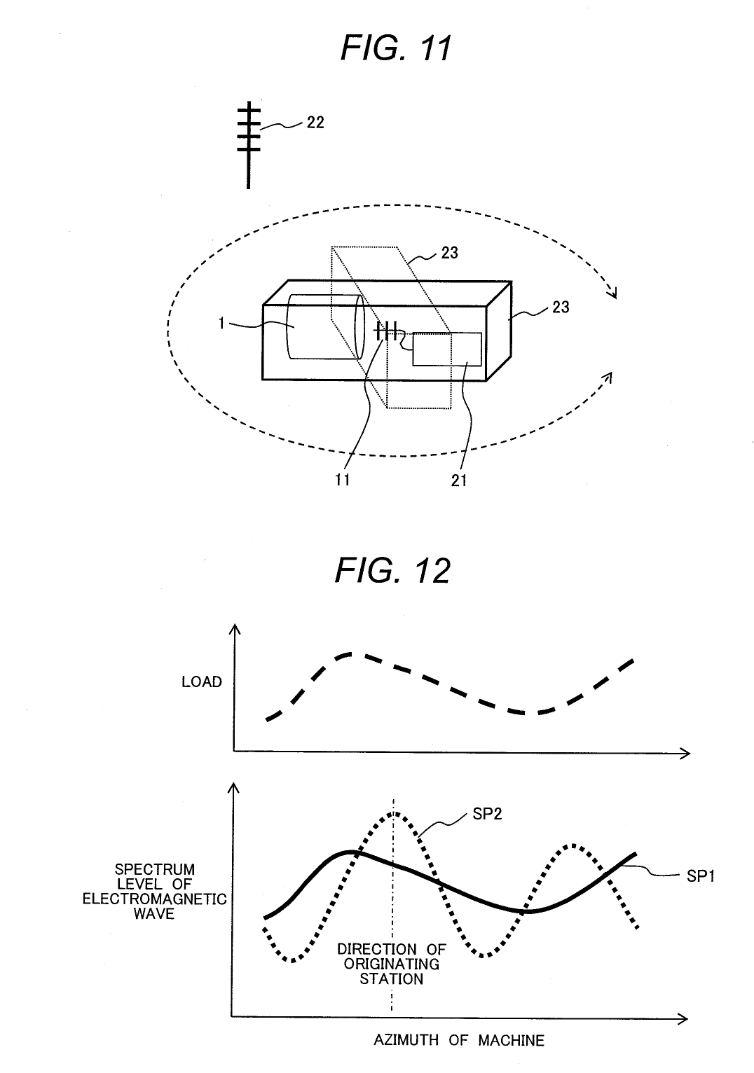

FIG. 12 is a characteristic diagram showing a frequency spectrum level of an electromagnetic wave with respect to an azimuth of equipment; and

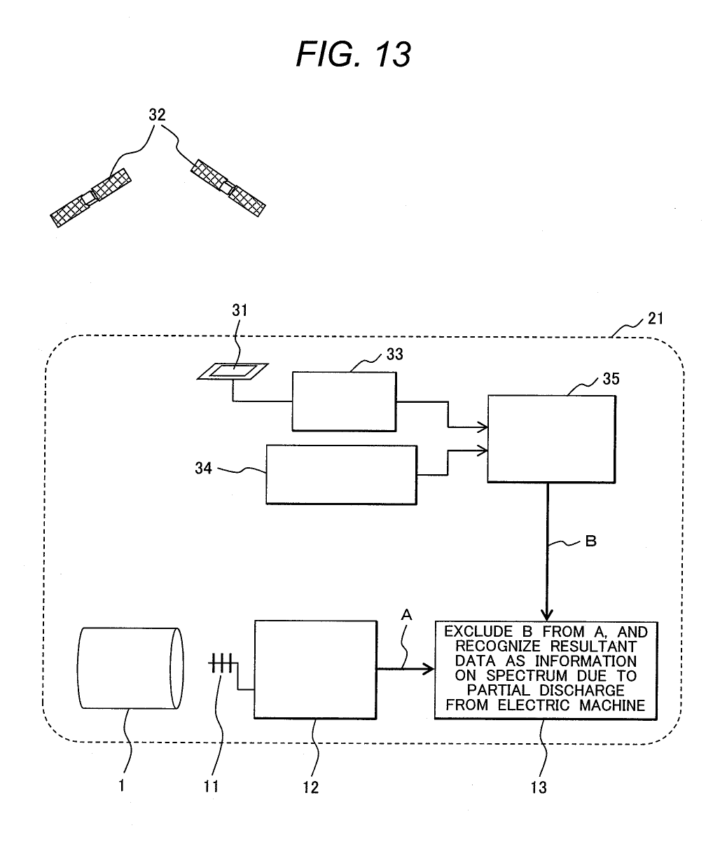

FIG. 13 is a block diagram showing a method of separating or discriminating a spectrum due to partial discharge by acquiring information on a frequency spectrum of an environmental electromagnetic wave on the basis of information on a location of equipment.

### DESCRIPTION OF THE PREFERRED EMBODIMENTS

Referring to the drawings, an embodiment of the present invention will be described below.

FIG. 2 shows an overall constitution of an insulation diagnostic unit for an electric machine in accordance with the present invention. Herein, an electromagnetic-wave sensor 11 is disposed near an electric machine 1, and a measured electromagnetic-wave signal is fetched into a signal processor 13 via a spectrum measuring instrument 12.

As the electromagnetic-wave sensor 11, an electromagnetic-wave antenna, an electric field probe, or a magnetic field probe may be adopted. As the measuring instrument 12, a spectrum analyzer, a signal data logger having a frequency analyzing feature, or a filter may be adopted. If necessary, an amplifier or an analog-to-digital converter may be included in the measuring instrument.

An attached installation 2 is connected to the electric machine 1, and inputs or outputs electric energy from or to the electric machine 1 over a power cable 3. When the electric machine 1 is a motor or the like, the attached installation 2 is a power supply. When the electric machine 1 is a power generator or the like, the attached installation 2 is a load. In this specification, a power to be inputted or outputted to or from the electric machine 1 shall be called a load. Information on the load is fetched into the signal processor 13.

An electromagnetic-wave signal actually fetched into the signal processor 13 exhibits many spectra. For a better understanding of the principles of the present invention, a description will be made of a simple case where the electromagnetic-wave signal exhibits two spectra A and B. In FIG. 2, a spectrum shown on the left side of the signal processor 13 is a spectrum exhibited when a load on the electric machine 1 is light. A spectrum shown on the right side thereof is a spectrum exhibited when the load on the electric machine 1 is heavy.

In the foregoing case, the level of the spectrum A remains nearly unchanged whether the load on the electric machine 1 is heavy or light. In contrast, as for the spectrum B, when the load on the electric machine 1 is light, the spectrum level is low. When the load is heavy, the spectrum level is high. At this time, the spectrum A may be recognized as a spectrum of an electromagnetic wave coming from an external environment, such as, a communication wave or a broadcast wave (that is, an environmental electromagnetic wave), while the spectrum B may be recognized as an electromagnetic wave deriving from partial discharge from the electric machine 1.

FIG. 3 is an explanatory diagram showing as an example of data processing employed in the present invention a case where data is digitally processed. A temporal wave of a voltage corresponding to an electromagnetic wave is outputted from the sensor 11, and sent to the measuring instrument 12. In the spectrum measuring instrument 12, after an analog-to-digital converter 121 performs analog-to-digital conversion, a time-to-frequency transform routine 122 performs, for example, fast Fourier transform to transform the digital signal into a frequency-vs.-level characteristic signal 100. The signal processor 13 fetches the frequency-vs.-level characteristic signal 100. The signal fetched into the signal processor 13 is a signal graphically expressed, as shown in FIG. 2, with a frequency indicated on the axis of abscissas and a spectrum level indicated on the axis of ordinates within a frame indicating the signal processor 13.

In addition, load information concerning the machine is fetched in the form of a digital value signal 101 into the signal processor 13. Further, location information 102 or azimuth information 103 concerning the electric machine or equipment including the electric machine is described as reference information.

In a memory 131 incorporated in the signal processor 13, a time of measurement, a load, a frequency, a level, and a location and azimuth information which are included if necessary are sequentially stored in association with one another. From among the data items stored in the memory 131, necessary data is extracted by an arithmetic block 132 at appropriate timing, and analyzed as a load characteristic of a spectrum level.

As one of analysis modes, there is a method of obtaining a correlation coefficient indicating a correlation of a spectrum level relevant to a frequency i to a load. Based on the relationship to a threshold determined in advance in consideration of an insulating material or an insulation system employed in the electric machine 1, a spectrum of an environmental electromagnetic wave or a spectrum of an electromagnetic wave due to partial discharge is recognized. The recognition will be described in conjunction with FIG. 4 by taking a spectrum level of an electromagnetic-wave signal for instance.

FIG. 4 is a diagram in which a load on the electric machine 1 is indicated on the axis of abscissas and a spectrum level of an electromagnetic-wave signal is indicated on the axis of ordinates. The spectra A and B described in conjunction with FIG. 2 are graphically expressed in the coordinate system. The spectrum A has a nearly identical spectrum level irrespective of the load on the electric machine 1, and is therefore expressed as a line parallel to the axis of abscissas. The spectrum A is therefore recognized as a spectrum of an environmental electromagnetic wave having nothing to do with the electric machine.

In contrast, the spectrum B described in conjunction with FIG. 2 has a spectrum level that varies depending on the magnitude of the load. In terms of a way of variation dependent on the load, a type that increases the spectrum level proportionally to the load (spectrum B1), a type that is saturated along with an increase in the load (spectrum B2), and a type that is saturated along with a decrease in the load (spectrum B3) are conceivable. The varying spectra B1, B2, and B3 have the spectrum levels thereof varied depending on an increase or decrease in the load on the electric machine, and can therefore be recognized as spectra of electromagnetic waves due to partial discharge from the electric machine.

A load characteristic of a spectrum level of an electromagnetic wave due to partial discharge is diversified by an effect of an insulating material, an insulation system, temperature, or humidity. FIG. 4 shows three characteristics. In addition, a hysteresis may be exhibited in relation to an increase or decrease in the load.

Next, referring to FIG. 5, a concrete example of a method of separating an electromagnetic wave, which derives from partial discharge from an electric machine, from an environmental electromagnetic wave on the basis of spectrum information and load information sent to the signal processor 13 will be described below.

FIG. 5 shows spectrum data items stored in the memory 131, which represent the frequency-vs.-level characteristic signal 100 obtained by the time-to-frequency transform routine 122 installed in the spectrum measuring instrument 12 shown in FIG. 3, by indicating a frequency on the axis of abscissas and a spectrum level on the axis of ordinates. Among the spectrum data items, the spectrum data items 1 are spectrum data items measured when a load is heavy, and the spectrum data items 2 are spectrum data items measured when the load is light. Needless to say, the two sets of spectrum data items 1 and 2 are spectrum data items that are obtained at different times of measurement under the different magnitudes of the load and then retrieved from the memory 131.

The two sets of spectrum data items 1 and 2 represent observed spectra a, b, c, etc., and j. Between the sets of spectrum data items, the spectra are observed at the same frequencies, that is, the same spectral positions. However, between the sets of spectrum data items, although the spectrum levels of some of the spectra are identical to those of counterparts, the spectrum levels of the others thereof are different from those of counterparts. More particularly, the spectra b, c, f, h, and j have the spectrum levels thereof varied depending on whether the load is heavy or light, while the spectra a, d, e, g, and i have the spectrum levels thereof held nearly constant irrespective of the load.

The spectra a, d, e, g, and i having the spectrum levels thereof held nearly constant irrespective of the load can be recognized as spectra of environmental electromagnetic waves independent of the electric machine 1. The spectrum data items 3 representing the spectra a, d, e, g, and i alone are obtained as data items representing environmental-electromagnetic wave spectra.

When the spectrum data 3 concerning an environmental electromagnetic wave alone is excluded from each of the spectrum data items 1 and 2, spectrum data 4 representing a spectrum deriving from partial discharge occurring when the load is heavy, and spectrum data 5 representing a spectrum deriving from partial discharge occurring when the load is light can be obtained. Between the spectrum data items 4 and 5, the spectral positions (frequencies) are identical to each other but the levels are different from each other.

Now, the environmental electromagnetic waves whose spectra are represented by the spectrum data items 3 include mainly a broadcast wave for television or the like and communication waves sent to or from portable cellular phones or various types of wireless devices. Specific frequencies are assigned to the environmental electromagnetic waves in advance. In contrast, the frequency of an electromagnetic wave due to partial discharge from an electric machine is determined with an electrostatic capacitance or an inductance dependent on the structure, dimensions, or material of the electric machine, and with the length of a cable serving as a radiation antenna or a structure around a route along which the cable is laid down.

Referring to FIG. 5, a technique of separating a spectrum of an environmental electromagnetic wave and a spectrum of an electromagnetic wave due to partial discharge from each other on the basis of two spectrum data items obtained at different times of measurement under different magnitudes of a load has been described. Next, a method of quantitatively discriminating the spectrum of an environmental electromagnetic wave and the spectrum of an electromagnetic wave due to partial discharge from each other will be described in conjunction with FIG. 6 and FIG. 7.

FIG. 6 and FIG. 7 indicate a load factor on the axis of abscissas and a relative value of a spectrum level on the axis of ordinates. In order to create the graphs, plural (about one hundred) data items of a specific spectrum (specific frequency components) alone are retrieved from among the data items stored in the memory 131 shown in FIG. 3. For example, FIG. 6 is created by retrieving 100 data items of the spectrum b shown in FIG. 5 from the memory 131, and FIG. 7 is created by retrieving 100 data items of the spectrum a shown in FIG. 5 from the memory 131. Therefore, the 100 data items of each of the spectra a and b represent a set of spectra generally observed at different times of measurement under different magnitudes of a load.

FIG. 6 and FIG. 7 are created by plotting all spectrum data items as values relative to a reference value, which is any of the fetched spectrum data items (a value relative to the reference value is set to 1), while indicating a load on the axis of abscissas and the spectrum level on the axis of ordinates. The plotted dots are replaced with triangles in FIG. 6 or circles in FIG. 7. Further, when a direction (tendency) indicated by the plotted dots is expressed with an approximate line, an approximate line Mb shown in FIG. 6 signifies a rightward rising tendency. Likewise, in FIG. 7, an approximate line Ma signifies a tendency of being independent of the load.

As a statistical technique of grasping the tendency as a numerical value, a well-known correlation coefficient is utilized. More particularly, when a correlation coefficient indicating the correlation between the load factor and spectrum level is obtained by taking the graph of FIG. 6 for instance, R=0.85 is obtained as indicated in the drawing. In contrast, when the characteristic of a spectrum of an environmental electromagnetic wave, for example, the spectrum a shown in FIG. 5 with respect to the load factor of the load on the electric machine is analyzed, it is expressed as shown in FIG. 7. In this case, the correlation coefficient is 0.07. Thus, using the correlation coefficient as a criterial index, the environmental electromagnetic wave and the electromagnetic wave due to partial discharge can be discriminated from each other.

As the correlation coefficient, a Pearson product-moment correlation coefficient can be utilized. In principle, the coefficient has no unit, and takes on a real number ranging from −1 to 1. When the coefficient is close to 1, two random variables are said to have a positive correlation. When the coefficient is close to −1, the random variables are said to have a negative correlation. When the coefficient is close to 0, the correlation between the random variables is feeble. In the case shown in FIG. 6, since the correlation coefficient is close to 1 or is 0.85, the spectrum level and load factor have the positive correlation. In the case shown in FIG. 7, the correlation coefficient is close to 0 or is 0.07, the correlation between them is feeble.

The correlation coefficient is obtained as mentioned above. In order to decide based on the calculated coefficient whether a spectrum is recognized as a spectrum of an environmental electromagnetic wave or a spectrum of an electromagnetic wave due to partial discharge, one or two values should be designated as a threshold for the recognition based on the correlation coefficient. For example, there is a method in which: assuming that α denotes the threshold, if a spectrum level is equal to or larger than α, a spectrum having the spectrum level is recognized as the spectrum of an electromagnetic wave due to partial discharge; and if the spectrum level falls below α, the spectrum having the spectrum level is not recognized as the electromagnetic waves due to partial discharge. Another method is such that: thresholds are set to two values α and β (β<α); a spectrum whose spectrum level is equal to or larger than a is recognized as the spectrum of an electromagnetic wave due to partial discharge; a spectrum whose spectrum level falls below β is recognized as the spectrum of an environmental electromagnetic wave; and a spectrum whose spectrum level falls below a and is equal to or larger than β is recognized as neither the spectrum of the environmental electromagnetic wave due to partial discharge not the spectrum of the environmental electromagnetic wave. Herein, the thresholds α and β are pre-determined for each electric machine.

FIG. 1 shows a processing flow conformable to the foregoing method of discriminating an electromagnetic wave due to partial discharge from an environmental electromagnetic wave. The processing flow includes two routines. When a description is made in consideration of the constitution shown in FIG. 3, one of the routines is regarded as a data acquisition routine of a preparatory stage equivalent to a stage of storage processing involving the spectrum measuring instrument 12 or memory 131. The second routine is a recognition routine of a succeeding stage that is executed in the arithmetic block 132.

In the data acquisition routine, first, at step S100, an electromagnetic wave is acquired from the sensor 11 at regular intervals. At step S101, spectrum analysis is carried out. At step S103, data is recorded in the data table. At step S102, load information concerning the electric machine is acquired synchronously with acquisition of spectrum data. The series of pieces of processing is repeated until a termination command is issued.

At step S103, when a certain number of data items has been recorded in the data table, the recognition routine of the succeeding stage is activated. In the recognition routine, first, at step S104, data of a spectrum that is an object of recognition, for example, the i-th data is selected from among plural spectrum data items acquired as shown in FIG. 5, and then read. Specifically, for example, a spectrum a is noted a spectrum relevant to a specific frequency, that is, as a spectrum represented by the i-th data. For example, 100 data items concerning the spectrum a are retrieved from the data table at step S103. Processing from the next step S104 to step S110 is performed based on the data items of the spectrum a.

Thereafter, at step S105, a load characteristic is analyzed as shown in FIG. 6 or FIG. 7. Specifically, assuming that the axis of abscissas indicates a load factor and the axis of ordinates indicates a relative value of a spectrum level, processing of plotting the 100 data items concerning the spectrum a in the coordinate system is carried out.

At step S106, a correlation coefficient R is calculated by utilizing, for example, the Pearson product-moment correlation coefficient. At steps S107 to S110, whether the spectrum a expresses an environmental electromagnetic wave or an electromagnetic wave due to partial discharge is decided based on the obtained correlation coefficient R. For the discrimination, a criterial threshold α and a criterial threshold β (where β<α) are preserved in advance. The criterial thresholds α and β are designated for each electric machine, and are normally set to 0.7 and about 0.3 respectively.

For the foregoing decision or recognition, first, at step S107, the correlation coefficient R is compared with the criterial threshold α predesignated for each electric machine. If the correlation coefficient R is larger than the threshold α, the electromagnetic-wave spectrum is recognized as a spectrum of an electromagnetic wave deriving from partial discharge (step S109). If the correlation coefficient R is smaller than the threshold α, the correlation coefficient R is compared with the other predesignated criterial threshold β at step S108. If the correlation coefficient R is smaller than the threshold β, the electromagnetic-wave spectrum is recognized as a spectrum of an environmental electromagnetic wave (step S110). Depending on spectrum data, neither the spectrum of an electromagnetic wave due to partial discharge nor the spectrum of an environmental electromagnetic wave may be recognized.

Finally, after recognition of one spectrum a is completed, the spectrum to be recognized next is dealt with at step S111, and the recognition routine is repeated. For example, the spectrum b shown in FIG. 5 is selected next, and the same processing as that mentioned above is repeated. As a result, finally, the last spectrum j shown in FIG. 5 is recognized as a spectrum of an environmental electromagnetic wave or a spectrum of an electromagnetic wave due to partial discharge. When all spectra should be continuously recognized, n in an equation employed in selecting the next spectrum at step S111 is equal to 1.

As mentioned above, for each spectrum, the spectrum is recognized as a spectrum of an environmental electromagnetic wave or a spectrum of an electromagnetic wave due to partial discharge. Therefore, finally, the spectra are, as shown in FIG. 5, grasped as spectrum data items 3 of environmental electromagnetic waves, spectrum data items 4 of electromagnetic waves due to partial discharge obtained when a load is heavy, and spectrum data items 5 of electromagnetic waves due to partial discharge obtained when the load is light.

According to the technique described in FIG. 1, the present invention can discriminate an environmental electromagnetic wave from an electromagnetic wave due to partial discharge. Referring to FIG. 8, an effect of a temporal element will be described below. FIG. 8 shows results of temporal response of a spectrum of an environmental electromagnetic wave and a spectrum of an electromagnetic wave due to partial discharge observed when a load on an electric machine varies along with the passage of time.

In a case shown in FIG. 8 in which the axis of abscissas indicates a time and the axis of ordinates indicates a load or a spectrum level of an electromagnetic wave, the load increases, decreases, and increases again along with the passage of time. At this time, the spectra of electromagnetic waves due to partial discharge drawn as curves B in FIG. 4 are characteristic of increasing or decreasing along with the increase or decrease in the load. Therefore, a spectrum SP1 whose spectrum level varies in line with a temporal change in the load is recognized as a spectrum of an electromagnetic wave deriving from partial discharge. The environmental electromagnetic wave drawn as a line A in FIG. 4 is characteristic of being unsusceptible to the increase or decrease in the load. Therefore, a spectrum SP2 whose spectrum level remains nearly constant irrespective of a change in the load is recognized as a spectrum of an environmental electromagnetic wave such as a broadcast wave or a communication wave.

As a spectrum whose level varies along with the passage of time, there is a spectrum SP3 whose level does not correlate with the change in the load. The spectrum SP3 is a spectrum of an illegal electromagnetic wave originating from mobility equipment or an electromagnetic wave generated from a machine which is different from the electric machine serving as an object and is operated nearby.

In the embodiment of the present invention shown in FIG. 1, a correlation coefficient is obtained at step S106. The spectrum SP1 has the spectrum level thereof recognized as being larger than the criterial threshold α, while the spectrum SP2 has the spectrum level thereof recognized as being smaller than the criterial threshold β. How about the spectrum SP3? The correlation of the spectrum SP3 with the change in the load on the electric machine is so feeble that the spectrum level thereof is recognized as being smaller than the criterial threshold β. The results shown in FIG. 8 signify that a result of assessment by the unit in accordance with the present invention is unsusceptible to a temporal element.

Incidentally, transient electromagnetic waves include, for example, a radio wave from an aircraft flying over, a radio wave from a train running nearby, and a radio wave from a patrol car. The radio waves are legal electromagnetic waves whose use in a particular area is permitted. A method of discriminating the radio waves will be described in relation with another embodiment of the present invention. Briefly, through discrimination based on information on the location of an electric machine, a decision can be made that the radio waves are not electromagnetic waves due to partial discharge from the electric machine.

Next, a discussion will be made of an effect of the position of mobility equipment on a result of assessment by the unit in accordance with the present invention in a case where the unit in accordance with the present invention is used while being mounted in the mobility equipment.

In a use state shown in FIG. 9, the electric machine 1 is mounted in mobility equipment 25. Therefore, assessment made by the insulation diagnostic unit is affected by, in addition to an electromagnetic wave generated from the electric machine 1, various environmental electromagnetic waves received along with movement. In this case, the electromagnetic wave generated from the electric machine 1 mounted in the mobility equipment 25 such as a train or an automobile is measured using the sensor 11 and spectrum measuring instrument 12 which are mounted in the mobility equipment. At this time, the electromagnetic wave has to be discriminated from an electromagnetic wave that originates from an environmental-electromagnetic wave originating station 22 and that is sensed by the sensor 11. In the drawing, reference numeral 25 denotes the mobility equipment including the insulation diagnostic unit.

FIG. 10 shows the relationship of a load on the electric machine 1 to the position of the mobility equipment 25, and the relationship of a spectrum level of an electromagnetic wave, which is measured by the sensor 11 mounted in the mobility equipment 25, to the position of the mobility equipment 25. The spectrum level of the spectrum SP1 of an electromagnetic wave due to partial discharge from the electric machine 1 varies depending on the load. In contrast, the level of the spectrum SP2 of an environmental electromagnetic wave radiated from the originating station 22 has nothing to do with the load on the electric machine. When the mobility equipment passes a point closest to the originating station 22, the level of the spectrum SP2 takes on a peak value. Before and after the mobility equipment passes the point closet to the originating station 22, the spectrum level takes on a smaller value. Based on the difference in the characteristic, the spectrum of an environmental electromagnetic wave and the spectrum of an electromagnetic wave deriving from partial discharge can be discriminated from each other.

In the embodiment of the present invention shown in FIG. 1, a correlation coefficient is obtained at step S106. The level of the spectrum SP1 is recognized as being larger than the criterial threshold α, while the level of the spectrum SP2 is recognized as being smaller than the criterial threshold β because it little correlates with a load. Therefore, extraction of the spectrum SP1 will not be adversely affected despite a shift of the position of the mobility equipment. This means that the insulation diagnostic unit in accordance with the present invention can be used while being mounted in the mobility equipment.

Next, a discussion will be made of how the position of rotative equipment affects a result of assessment made by the insulation diagnostic unit in accordance with the present invention in a case where the insulation diagnostic unit is used while being mounted in the rotative equipment.

In a use state shown in FIG. 11, the electric machine 1 is mounted in azimuth movable equipment 23. Assessment made by the insulation diagnostic unit is affected by, in addition to an electromagnetic wave generated from the electric machine, various environmental electromagnetic waves received along with rotation. In this case, the relationship between a spectrum of an electromagnetic wave due to partial discharge occurring in the electric machine 1 mounted in the azimuth movable equipment 23, and a spectrum of an environmental electromagnetic wave will be described below. The azimuth movable equipment 23 is, for example, wind power generation equipment, and the electric machine 1 in this case is a power generator. The azimuth of the wind power generation equipment is turned in line with a wind direction. In contrast, the environmental-electromagnetic wave originating station 22 is stationary.

FIG. 12 shows an example of characteristics of the spectra of electromagnetic waves, which are observed by the sensor 11 and measuring instrument 12 that are mounted, with respect to the azimuth of the azimuth movable equipment 23. The spectrum level of an electromagnetic wave due to partial discharge varies depending on a load on the electric machine 1, while the spectrum level of an environmental electromagnetic wave is observed to be maximized in the direction of the originating station 22. Depending on the type of sensor 21, the spectrum level of the environmental electromagnetic wave may take on the second peak value at a position forming an angle of 180° with respect to the originating station 22. Based on the load and azimuth characteristics of the thus measured spectra of the electromagnetic waves, the environmental electromagnetic wave and the electromagnetic wave due to partial discharge can be discriminated from each other.

In the case shown in FIG. 12, the load increases, decreases, and increases again along with a change in the azimuth of the electric machine. At this time, a spectrum SPI whose level varies in line with a change in the load caused by the change in the azimuth is recognized as a spectrum of an electromagnetic wave deriving from partial discharge. A spectrum SP2 whose level takes on a peak value at a certain position when the azimuth is changed, and takes on a smaller value before and after the azimuth is changed is recognized as a spectrum of an environmental electromagnetic wave such as a broadcast wave from the stationary originating station 22 or a communication wave.

In the embodiment of the present invention shown in FIG. 1, a correlation coefficient is obtained at step S106. The level of the spectrum SP1 is recognized as being larger than the criterial threshold α, while the level of the spectrum SP2 is recognized as being smaller than the criterial threshold β because it little correlates with the load. Extraction of the spectrum SP1 will not be adversely affected despite a variation in the azimuth of the machine. This means that the insulation diagnostic unit in accordance with the present invention can be used while being mounted in the azimuth movable equipment 23.

FIG. 13 shows as another embodiment of the present invention a system and method that detect partial discharge from an electric machine mounted in mobility equipment. Information A on an electromagnetic-wave spectrum is acquired using the sensor 11 and measuring instrument 12 disposed near the electric machine 1 mounted in the mobility equipment 21, and fetched into the signal processor 13.

The mobility equipment 21 is provided with a global positioning system (GPS) antenna 31, and thus receives signals from GPS satellites 32. A positional information detector 33 acquires information on the location of the mobility equipment 21. The mobility equipment 21 has an area-by-area electromagnetic-wave frequency table 34. In the table, electromagnetic-wave frequencies whose use is permitted are recorded in association with areas.

On receipt of the information from the positional information detector 33 and the information retrieved from the area-by-area electromagnetic-wave frequency table 34, an environmental electromagnetic wave extraction routine 35 acquires information B on a spectrum of an environmental electromagnetic wave propagated in an area where the mobility equipment exists. The information B is fetched into the signal processor 13. The signal processor 13 obtains, as described in conjunction with FIG. 4, a result of excluding the information B from the information A, and recognizes the resultant data as information on a spectrum of an electromagnetic wave deriving from partial discharge from the electric machine 1.

An example of the mobility equipment described in the present embodiment is a train that runs a long distance of several hundreds of kilometers at a high velocity without a stop. Even when the train runs over areas in which different frequencies of electromagnetic waves are permitted to be used, an environmental electromagnetic wave permitted in an area where the train exists can be accurately grasped. This is effective in reducing a possibility that an electromagnetic wave deriving from partial discharge from an electric machine such as a mounted motor or converter may be missed. Another example of the mobility equipment is an automobile that runs on an expressway and uses electric power as a drive source. An environmental electromagnetic wave permitted to be used in an area where the automobile exists, and an electromagnetic wave due to partial discharge occurring in an electric machine mounted in the automobile can be properly separated or discriminated from each other.

In a square indicating the signal processor 13 in FIG. 13, it is described that since an inherent frequency granted permission to use in each area is already known, the component B should be excluded. Nevertheless, the sensor 11 catches various kinds of environmental electromagnetic waves. Therefore, needless to say, it would prove effective if the aforesaid various separation techniques are combined and implemented.

According to the present invention, a state of deterioration of an electric machine can be continuously measured. Especially when the electric machine is mounted in mobility equipment, a situation of partial discharge can be grasped. Therefore, the present invention can be applied to diverse electric machines.

What is claimed is:

1. An insulation diagnostic unit for an electric machine comprising:
a sensor disposed near an electric machine;
an instrument that performs spectrum analysis on an output of the sensor;
a load detection method for the electric machine;
a data table in which an output of the load detection method and an output of the spectrum analysis instrument are recorded;
a first routine that notes a spectrum relevant to a specific frequency, which is obtained by the spectrum analysis instrument, from among data items recorded in the data table, and obtains a correlation coefficient on the basis of a plurality of data items concerning magnitudes of the noted spectrum, and a plurality of data items of a load obtained at the times of measurement of the plurality of data items; and
a second routine that classifies the noted spectrum relevant to the specific frequency into a spectrum of an environmental electromagnetic wave or a spectrum of an electromagnetic wave due to partial discharge from the electric machine on the basis of the value of the correlation coefficient obtained by the first routine.

2. The insulation diagnosis unit for an electric machine according to claim 1, further comprising a third routine that sequentially changes the spectrum relevant to the specific frequency, which is noted from among the data items recorded in the data table, and repeatedly executes the first routine and second routine, wherein:
frequency components of an electromagnetic wave due to partial discharge from the electric machine are obtained.

3. The insulation diagnosis unit for an electric machine according to claim 1, wherein the electric machine and the insulation diagnostic unit for the electric machine are mounted in mobility equipment.

4. The insulation diagnosis unit for an electric machine according to claim 1, wherein the electric machine and the insulation diagnostic unit for the electric machine are mounted in rotative equipment.

5. The insulation diagnosis unit for an electric machine according to claim 1, wherein:
when the value of the correlation coefficient obtained by the first routine is close to 1, the spectrum concerned is recognized as a spectrum of an electromagnetic wave due to partial discharge; and
when the value of the correlation coefficient is close to 0, the spectrum concerned is recognized as a spectrum of an environmental electromagnetic wave.

6. The insulation diagnosis unit for an electric machine according to claim 3, further comprising a detector that detects a position of mobility equipment, and a memory in which electromagnetic-wave frequencies that are granted permission to use are stored in association with areas in which the position of the mobility equipment exists, wherein:
based on the output of the detector that detects the position of the mobility equipment, the electromagnetic-wave frequency stored in the memory in association with the area in which the position exists is excluded from the output of the spectrum analysis instrument, and the resultant data is recorded in the data table.

7. An insulation diagnostic algorithm for an electric machine, comprising the steps of:
fetching data, which results from spectrum analysis of an electromagnetic wave measured around an electric machine, and a load imposed on the electric machine;
collating a plurality of data items of a specific spectrum out of data items, which result from the spectrum analysis, with the load on the electric machine;
recognizing the specific spectrum, which has the magnitude thereof varied along with a change in the load on the electric machine, as frequency components of an electromagnetic wave due to partial discharge from the electric machine; and
recognizing a spectrum, which is independent of the change in the load, as frequency components of an environmental electromagnetic wave.

8. The insulation diagnosis algorithm for an electric machine according to claim 7, wherein:
pieces of information on electromagnetic-wave frequencies that are granted permission to use are preserved in association with areas;
when the electric machine is located in any of the areas, the electromagnetic-wave frequency granted permission to use in the area is excluded from the data resulting from the spectrum analysis; and
a plurality of data items of the specific spectrum are collated with the load on the electric machine.

9. Equipment including the insulation diagnostic unit for an electric machine, comprising:
an electric machine; and
an insulation diagnostic unit including
a sensor disposed near the electric machine,
an instrument that performs spectrum analysis on an output of the sensor,
a load detection method for the electric machine,
a data table in which an output of the load detection method and an output of the spectrum analysis instrument are recorded,
a first routine that notes a spectrum relevant to a specific frequency, which is obtained by the spectrum analysis instrument, from among data items recorded in the data table, and obtains a correlation coefficient on the basis of a plurality of data items concerning the magnitudes of the spectrum and a plurality of data items of a load; and
a second routine that classifies the noted spectrum relevant to the specific frequency into a spectrum of an environmental electromagnetic wave or a spectrum of an electromagnetic wave due to partial discharge from the electric machine on the basis of the value of the correlation coefficient obtained by the first routine.

10. The equipment including an insulation diagnostic unit for an electric machine according to claim 9, wherein the equipment is mobility equipment.

11. The equipment including an insulation diagnostic unit for an electric machine according to claim 9, wherein the equipment is rotative equipment.

12. The equipment including an insulation diagnostic unit for an electric machine according to claim 9, further comprising a detector that detects a position of mobility equipment, and a memory in which electromagnetic-wave frequencies that are granted permission to use are stored in association with areas where the position of the mobility equipment exists, wherein:
based on an output of the detector that detects the position of the mobility equipment, the electromagnetic-wave frequency stored in the memory in association with the area in which the position exists is excluded from the output of the spectrum analysis instrument, and the resultant data is recorded in the data table.
